(19) United States
(12) Patent Application Publication
(10) Pub. No.: US 2026/0102718 A1
(43) Pub. Date: Apr. 16, 2026

(54) PLATE MODULE OF AN INCLINED PLATE SETTLER

(71) Applicants: Valeri Schneider, Zug (CH); Daniel SUTYAGINSKIY, Seigburg (DE)

(72) Inventors: Valeri Schneider, Zug (CH); Daniel SUTYAGINSKIY, Seigburg (DE)

(21) Appl. No.: 18/977,426

(22) Filed: Dec. 11, 2024

(30) Foreign Application Priority Data
Oct. 15, 2024 (EP) 24206624.9

(51) Int. Cl. B01D 21/00

(52) U.S. Cl. CPC B01D 21/0045; B01D 21/0006; B01D 21/0069

(57) ABSTRACT

A plate module of an inclined plate settler with a plurality of lamella plates positioned parallel to one another and secured at an angle to the horizontal in the installed state, wherein the plate module is embodied as a plug-in system with end plates between which a plurality of longitudinal plates extend and the lamella plates are secured on the longitudinal plates between the end plates, wherein the connections between the end plates and longitudinal plates and/or between the longitudinal plates and lamella plates are embodied as detachable plug-in connections.

### CROSS-REFERENCE TO RELATED APPLICATION

European Patent Application No. EP 24206624.9, filed 15 Oct. 2024, the priority document corresponding to this invention, to which a foreign priority benefit is claimed under Title 35, United States Code, Section 119, and its entire teachings are incorporated, by reference, into this specification.

### BACKGROUND OF THE INVENTION

### Field Of The Invention

This invention relates to a plate module of an inclined plate settler with a plurality of lamella plates positioned parallel to one another and secured at an angle to the horizontal when installed.

### Discussion of Related Art

Inclined plate settlers, also known as lamella clarifiers, are sedimentation systems that are used in settling basins of a water purification plant to treat the water flowing through by settling. They often include lamella plates, which are aligned parallel to one another, through which the water flows. The effect of this is that the sediments from the water only have to sink through a small distance of a few centimeters between the lamella plates instead of the entire depth of the settling basin. This results in a significantly better separating action. When installed, the lamella plates are positioned at an angle to the horizontal to allow the settled sludge to slide down to the bottom of the basin. An example of this can be found in German Patent Reference DE 20 30 618 A1.

To facilitate the manufacture and assembly of such inclined plate settlers, the industry has already transitioned to combining the lamella plates into plate modules, the required number of which are then suspended in the settling basin. The plate modules are usually prefabricated as a welded construction and weigh a considerable amount. Transportation to the installation site is also complicated due to the size of the components. The plate modules are suspended from support beams and after insertion into the settling basin, dead zones form in the parts that are not filled with plate modules, requiring the settling basins to be pumped out and cleaned periodically. All of this appears to be in need of improvement.

### SUMMARY OF THE INVENTION

One object of this invention is to provide a plate module of an inclined plate settler of the type mentioned at the beginning, which can be flexibly adapted to a wide variety of installation situations and in particular sizes of settling basins, can be efficiently prefabricated, and with little effort, assembled at the installation site so that they are ready to use, and inserted into the settling basin.

To attain this object and others, this invention proposes embodying a plate module of an inclined plate settler in accordance with the features described in this specification and in the claims.

In addition, this invention also relates to a settling basin with at least one plate module according to this invention which can be suspended in the top of the settling basin.

According to this invention, the plate module can be embodied in the form of a plug-in system of prefabricated elements. This plug-in system comprises end plates, between which a plurality of longitudinal plates extend, and a plurality of lamella plates, which are secured on the longitudinal plates between the end plates, wherein the connections between the end plates and longitudinal plates and/or between the longitudinal plates and lamella plates are embodied as detachable plug-in connections. Preferably, all of the connections between the end plates and longitudinal plates and between the longitudinal plates and lamella plates are embodied as detachable plug-in connections.

According to this invention, it is possible to prefabricate the elements of the plug-in system for embodying the plate module according to this invention, namely end plates, longitudinal plates, and lamella plates, in mass production with extensive use of identical parts and to transport them to the installation site in a space-saving manner. Upon arrival at the installation site, the detachable plug-in connections permit the elements to be plugged together with little effort and preferably without tools in order to build the ready-to-use plate module. Adjustments to the geometry and the prevailing spatial conditions of the settling basin can be easily made by varying the number and size of the end plates, longitudinal plates, and/or lamella plates used.

According to some embodiments of this invention, the end plates of each longitudinal plate have an associated arrangement of insertion slots into which corresponding hooks projecting from the ends of the longitudinal plates can be detachably inserted. In this way, a preferably right-angled connection between the end plates and the longitudinal plates can be easily produced by inserting the projecting hooks of the longitudinal plates into the slots provided in the end plates.

According to some embodiments of this invention, each longitudinal plate, starting from a longitudinal edge extending along an upper side in the installed state, has a plurality of insertion slots extending at an angle to the horizontal and each lamella plate, starting from a longitudinal edge of each longitudinal plate extending along a lower side in the installed state, has an associated insertion slot of a length corresponding to the length of the insertion slots of the longitudinal plate so that the longitudinal plates and the lamella plates can be detachably plugged into one another in the region of the insertion slots, crossing at right angles. The insertion slots in the longitudinal plates, which extend at an angle to the horizontal, not only determine the distance between adjacent lamella plates, but also secure them in the desired orientation in which they are secured at an angle to the horizontal, for example at an angle of 60°, when installed.

According to some embodiments of this invention, the longitudinal plates have a plurality of openings adjacent to the underside extending on the opposite side from the upper side, which serve to permit entry of the water that is to be cleaned.

According to some embodiments of this invention, in the installed state, crossbars can extend between the end plates below the lamella plates, which crossbars, in the region of their upper side facing the lamella plates, each have insertion recesses for the insertion of a lamella plate and can be detachably inserted into corresponding clamping slots of the end plates at the ends by projecting clamping hooks. The crossbars serve as a lower end stop for the lamella plates inserted into the slots of the longitudinal plates and at the same time, fix the end plates, which define the respective ends of the plate module, in their position relative to each other.

According to one embodiment of this invention, in the installed state, an upper side of the longitudinal plates is inserted in a detachably clamping manner into a clamping strip in the region of an insertion slot formed in the clamping strip. This clamping strip provides the plate module with a high degree of stability and at the same time, aligns the lamella plates, which are inserted into the longitudinal plates, precisely with one another.

According to one embodiment of this invention, the plate module according to this invention is embodied with retaining rods at the top in the installed state and with rollers secured on the retaining rods, by which it is possible for the plate module to be suspended on a support beam of a settling basin. In particular, the retaining rods can be fixed to the clamping strip and are affixed to the rollers at their opposite ends so that the entire plate module can be slid along the rollers into a correspondingly rail-like support beam and then easily travel into the settling basin. If a cleaning is required, then the plate modules can just as easily be moved out of the settling basin in the opposite direction and cleaned.

The assembly of the plate module according to this invention out of the end plates, longitudinal plates, and lamella plates that can be plugged into one another with plug-in connections can also be facilitated by the fact that the end plates are embodied with a flange on the top and/or the longitudinal plates and/or the lamella plates are embodied with holes at the top for engagement by a hoist in order to be able to move the components mechanically.

The end plates, longitudinal plates, and/or lamella plates can, for example, be prefabricated from sheet metal such as stainless steel sheet and, for example, laser-cut to their specific shape, but it is also possible to manufacture them from suitable plastic, in particular fiber-reinforced hard plastics.

According to one embodiment of this invention, the lamella plates are embodied with a gradually increasing width starting from one end plate to the other end plate in such a way that the plate module is conical when viewed in the vertical projection. A large number of such conically shaped plate modules, when joined together along the longitudinal plates, produce an annular arrangement so that the plate modules according to this invention can also be to fill circular settling basins without having to accept the creation of undesirable dead spaces.

Finally, this invention also includes a settling basin with at least one plate module that can be suspended in the top of the settling basin as described above.

### BRIEF DESCRIPTION OF THE DRAWINGS

Further embodiments and details of this invention are explained below with reference to exemplary embodiments in the drawings, wherein:

FIG. 1 shows a perspective top view of a rectangular settling basin including plate modules according to this invention;

FIG. 2 shows a cutaway side view of the settling basin shown in FIG. 1;

FIG. 3a shows a side view of a plate module according to this invention;

FIG. 3b shows the enlarged detail indicated in FIG. 3a;

FIG. 3c shows the plate module according to FIG. 3a in an end view that is rotated by 90°;

FIG. 4 shows a view of an end plate of the plate module according to this invention;

FIG. 5 shows a view of a longitudinal plate of the plate module according to this invention;

FIG. 6 shows a view of a lamella plate of the plate module according to this invention;

FIG. 7 shows a side view of a crossbar of the plate module according to this invention;

FIG. 8 shows a view of a clamping strip of the plate module according to this invention; and

FIG. 9 shows a top view of a round settling basin composed of plate modules according to this invention;

FIG. 10 shows a top view of the plate module shown in FIG. 9.

### DETAILED DESCRIPTION OF INVENTION

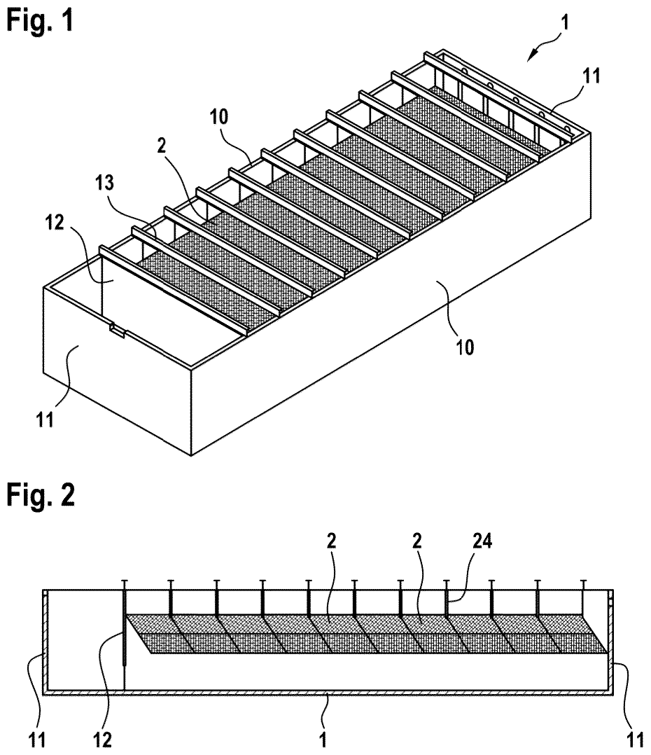

FIGS. 1 and 2 show a rectangular settling basin 1, formed by longitudinal walls 10 and transverse walls 11, which is divided into two spaces of different sizes by a partition wall 12. Plate modules 2 of an inclined plate settler are suspended from support beams 13 in the larger of the two spaces in order to settle sediment from the liquid, usually rainwater or wastewater, which is fed into the settling basin 1. The plate modules 2 are dimensioned so that they almost completely fill the settling basin 1 without any lateral dead spaces relative to the longitudinal and transverse walls 10, 11.

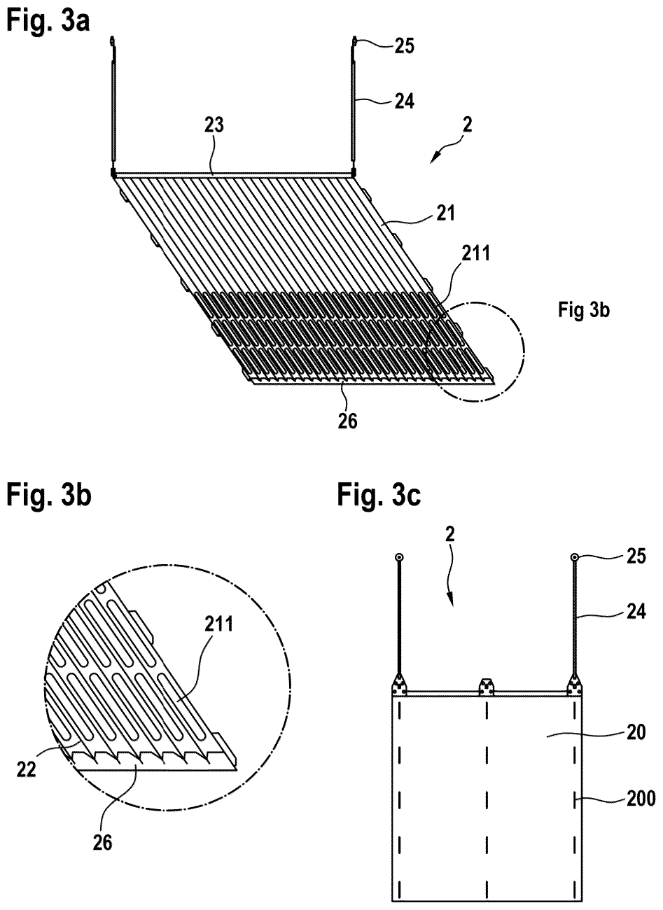

According to the depictions in FIGS. 3a to 3c, each individual plate module 2 has a structure comprising components that are detachably plugged into one another. End plates 20 as shown in FIG. 3c are provided at the ends, between which a total of three longitudinal plates 21 extend at right angles to the end plates 20 in the exemplary embodiment shown, which longitudinal plates are positioned congruently one behind another in the plane of the drawing in the depiction in FIG. 3a.

In addition, a plurality of lamella plates 22 are secured on the longitudinal plates 21 at an angle to the horizontal in a manner described in greater detail below and produce the actual settling process. For position-fixing, clamping strips 23 extend along the top of the longitudinal plates 21 and crossbars 26 extend along the bottom, into which the bottom ends of the lamella plates 22 are inserted in the manner described in greater detail below.

It is also apparent that retaining rods 24 with rollers 25 positioned at the top are attached to the upper clamping strips 23, with which the individual plate modules 2 can be inserted laterally into the support beams 13 and lowered from there into the settling basin 1.

Preferably, the design of the plate module 2 that its components, namely the end plates 20, longitudinal plates 21, and lamella plates 22, are all detachably fastened to one another, preferably without tools, as a plug-in system with detachable plug-in connections.

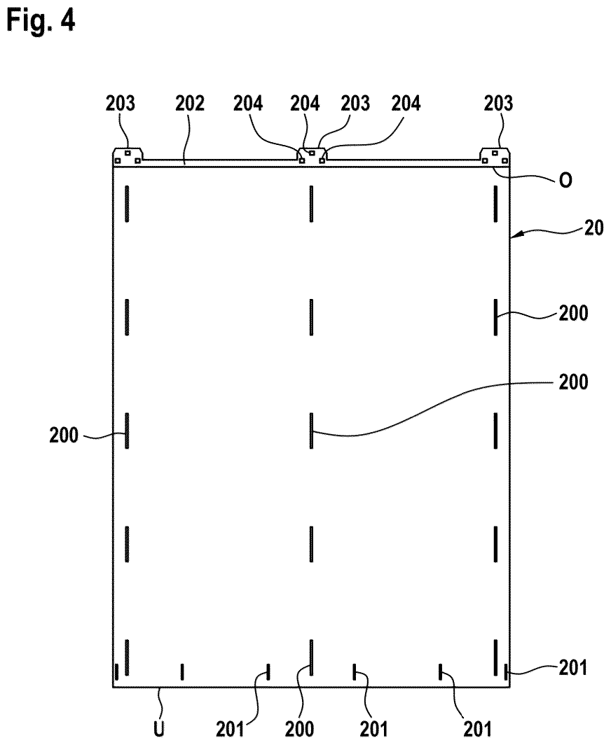

For this purpose, the two end plates 20 that are each provided on the end surface as the final and outermost plate have a rectangular design as shown in FIG. 4, with the upper side in the installed state marked O and the lower side in the installed state marked U, as is also the case in the following descriptions of the longitudinal plates 21 and lamella plates 22.

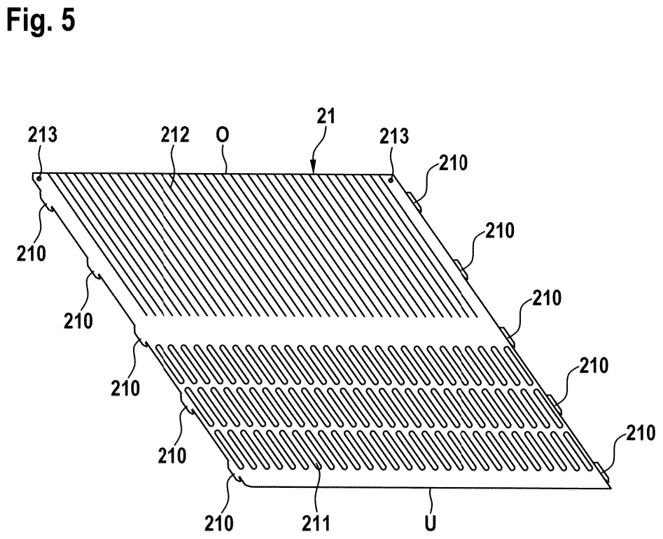

In the end plates 20, a plurality of insertion slots 200 are formed in three rows in the present case, for which purpose the end plate 20 is for example laser-cut from a stainless steel sheet. For example, five insertion slots 200 positioned equidistantly one above another in three rows are shown here, namely one along the left edge, one along the center line, and one along the right edge. These rows of slots 200 each serve to accommodate a longitudinal plate 21, further details of which can be seen in FIG. 5.

Accordingly, the longitudinal plates 21 are each embodied at their two opposite end faces with five projecting end hooks 210, which can be inserted into a row of the insertion slots 200 of the end plates 20 and detachably locked in position there so that it is possible to achieve a right-angled alignment of the longitudinal plates 21 between the end plates 20, which are spaced apart by the width of the longitudinal plates 21. In the exemplary embodiment shown, three longitudinal plates 21 extend between the two end plates 20.

The longitudinal plates 21 have a plurality of insertion slots 212 starting from the upper side O and extending over substantially half their height between the upper side O and the lower side U, which extend equidistantly parallel to one another at an angle to the horizontal, for example 60° in this case, as is desirable for the positioning of the lamella plates 22.

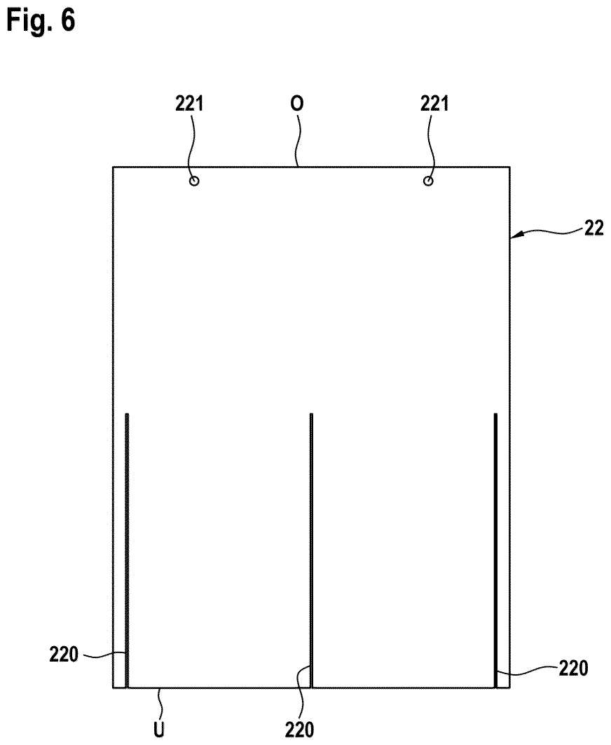

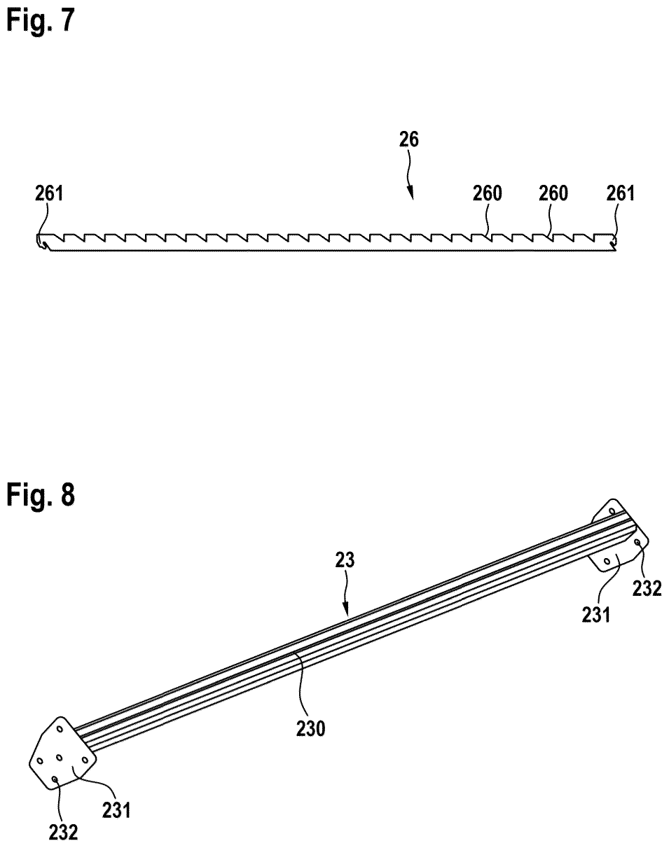

Accordingly, the lamella plates 22 shown in FIG. 6 are correspondingly equipped with insertion slots 220 extending the same length as the insertion slots 212, from the lower side U to approximately the middle so that it is possible to insert a plurality of lamella plates 22 each with the insertion slot 220 into one of the insertion slots 212 of the longitudinal plates 21 in an intersecting arrangement. This makes it easy to attach a large number of lamella plates 22 in the desired orientation. On the underside, the lamella plates 22 rest on a plurality of crossbars 26 extending between the end plates 20, which can be seen in FIG. 7. The crossbars 26 engage in corresponding clamping slots 201 of the end plates 20 by means of clamping hooks 261 projecting from the ends and produce an additional position-fixing. The crossbars 26 are also provided on the upper side with insertion recesses 260, which respectively engage with the lower edge region of the lamella plates 22 inserted into the longitudinal plates 21.

Furthermore, as shown in FIG. 4, the end plates 20 are provided along their upper side O with a flange 202, which, corresponding to the arrangement of the rows of insertion slots 200, has mounting surfaces 203 in which a plurality of mounting holes 204 are provided. The clamping strips 23 shown in FIG. 8 are then fitted onto the longitudinal plates 21 extending at right angles from the end plates 20 with the lamella plates 22 inserted at right angles thereto, by inserting the edge of the longitudinal plates 21 extending along the upper side O into a lower insertion slot 230 of the clamping strip 23 in a clamping manner. In this way, not only are all the lamella plates 22 aligned at the top, but the fastening flanges 231 with holes 232 provided at the end of the clamping strip 23 are then also congruent with the holes 204 in the mounting surfaces 203 on the end plates 20, enabling a durable attachment, for example by screws. In addition, the retaining rods 24 with rollers 25 can then be fastened to these flanges 231.

The assembly of the plate module 2 according to this invention is also facilitated by the fact that the end plates with the top flange 202 can be easily grasped and transported by a suitable hoist. The longitudinal plates 21 according to FIG. 5 are also embodied with holes 213 formed on the upper side O and the lamella plates 22 according to FIG. 6 are embodied with corresponding holes 221 for the engagement of such a hoist, in order to be able to move the components mechanically.

It is thus possible to form a plate module 2 almost without tools using detachable plug-in connections between the end plates 20, the lamella plates 22, and the longitudinal plates 21 connecting them. During operation of these plate modules 2, the water to be cleaned is introduced into the spaces between adjacent lamella plates 22 via openings 211 formed below the insertion slots 212 in the longitudinal plates 21 so that the sediments can settle in an intrinsically known way.

By varying the number and size of the individual end plates 20, longitudinal plates 21, and/or lamella plates 22, a plate module 2 can be varied such that it is possible to completely fill settling basins 1 of different sizes without creating dead spaces.

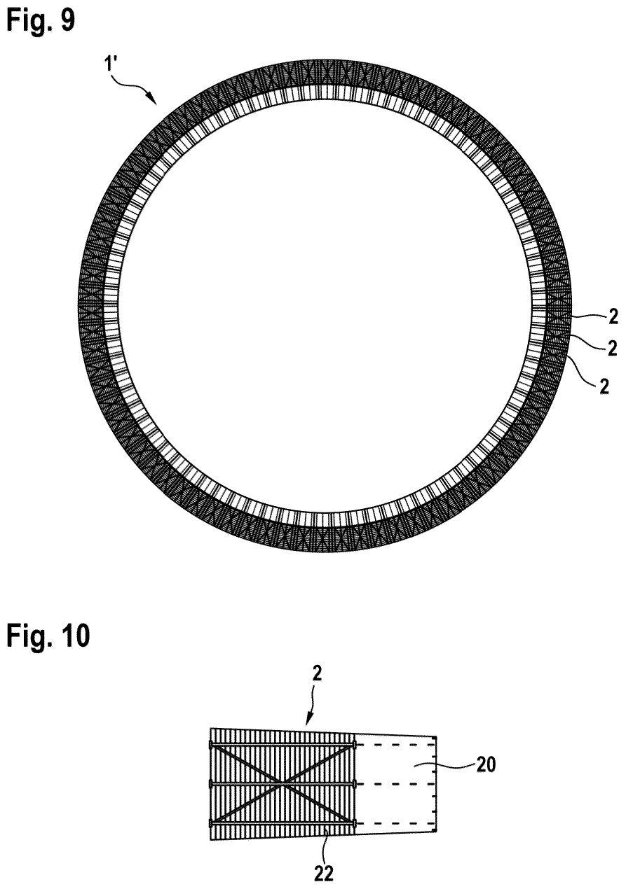

In the exemplary embodiment shown in FIG. 9, a round settling basin 1′ is also visible, which is filled in an annular shape with plate modules 2 as shown in FIG. 10. By contrast with the plate module 2 according to FIGS. 1 to 8, this plate module 2 according to FIG. 10 has the lamella plates 22 secured on the longitudinal plates 21 have gradually increasing widths from the right end plate 20 here to the left end plate 20 so that the plate module 2 widens conically from right to left when viewed in the vertical projection and in the graphic representation according to FIG. 10. If such conically widening plate modules 2 are joined together in the region of their longitudinal plates 21 as shown in FIG. 9, the result is a circular ring-shaped arrangement that is suitable for insertion into circular settling basins 1′ without creating dead spaces.

While in the foregoing specification this invention has been described in relation to certain preferred embodiments, and many details are set forth for purpose of illustration, it will be apparent to those skilled in the art that this invention is susceptible to additional embodiments and that certain of the details described in this specification and in the claims can be varied considerably without departing from the basic principles of this invention.

1. A plate module (2) of an inclined plate settler with a plurality of lamella plates (22) positioned parallel to one another and secured at an angle to the horizontal in the installed state, comprising: the plate module (2) embodied as a plug-in system with end plates (20) between which a plurality of longitudinal plates (21) extend and the lamella plates (22) are secured on the longitudinal plates (21) between the end plates (20), with the connections between the end plates (20) and longitudinal plates (21) and/or between the longitudinal plates (21) and lamella plates (22) being detachable plug-in connections.

2. The plate module (2) according to claim 1, wherein the end plates (20) of each longitudinal plate (21) have an associated arrangement of insertion slots (200) into which corresponding hooks (210) projecting from the ends of the longitudinal plates (21) can be detachably inserted.

3. The plate module (2) according to claim 2, wherein each longitudinal plate (21), starting from a longitudinal edge extending along an upper side (O) in the installed state, has a plurality of insertion slots (212) extending at an angle to the horizontal, and each lamella plate (22), starting from a longitudinal edge of each longitudinal plate (21) extending along a lower side (U) in the installed state, has an associated insertion slot (220) of a length corresponding to the length of the insertion slots (212) of the longitudinal plate (21), so that the longitudinal plates (21) and the lamella plates (22) can be detachably plugged into one another in the region of the insertion slots (212, 220), crossing one another at right angles.

4. The plate module (2) according to claim 3, wherein the longitudinal plates (21) have a plurality of openings (211) adjacent to the underside (U) extending on the opposite side from the upper side (O).

5. The plate module (2) according to claim 4, wherein in the installed state, crossbars (26) extend between the end plates (20) below the lamella plates (22), which crossbars, in the region of their upper side facing the lamella plates (22), each have insertion recesses (260) for the insertion of a lamella plate (22) and can be detachably inserted into corresponding clamping slots (201) of the end plates (20) at the ends by projecting clamping hooks (261).

6. The plate module (2) according to claim 5, wherein in that in the installed state, an upper side (O) of the longitudinal plates (21) is inserted in a detachably clamping manner into a clamping strip (23) in the region of an insertion slot formed in the clamping strip (23).

7. The plate module (2) according to claim 6, wherein it is embodied with retaining rods (24) at the top in the installed state and with rollers (25) secured on the retaining rods (24), by which it is possible for the plate module (2) to be suspended on a support beam (13) of a settling basin (1, 1′).

8. The plate module (2) according to claim 7, wherein the end plates (20) are embodied with an upper flange (202) and/or the longitudinal plates (21) and/or the lamella plates are embodied with upper holes (221, 232) for a hoist.

9. The plate module (2) according to claim 8, wherein the end plates (20), longitudinal plates (21), and/or lamella plates (22) are made of sheet metal or plastic.

10. The plate module (2) according to claim 9, wherein the lamella plates (22) are embodied with a gradually increasing width starting from one end plate (20) to the other end plate (20) so that the plate module (2) is conical when viewed in the vertical projection.

11. A settling basin (1, 1′) having at least one plate module (2) according to claim 10, which can be suspended in the settling basin (1, 1′) on the upper side.

12. A settling basin (1, 1′) having at least one plate module (2) according to claim 1, which can be suspended in the settling basin (1, 1′) on the upper side.

13. The plate module (2) according to claim 1, wherein each longitudinal plate (21), starting from a longitudinal edge extending along an upper side (O) in the installed state, has a plurality of insertion slots (212) extending at an angle to the horizontal, and each lamella plate (22), starting from a longitudinal edge of each longitudinal plate (21) extending along a lower side (U) in the installed state, has an associated insertion slot (220) of a length corresponding to the length of the insertion slots (212) of the longitudinal plate (21), so that the longitudinal plates (21) and the lamella plates (22) can be detachably plugged into one another in the region of the insertion slots (212, 220), crossing one another at right angles.

14. The plate module (2) according to claim 1, wherein the longitudinal plates (21) have a plurality of openings (211) adjacent to the underside (U) extending on the opposite side from the upper side (O).

15. The plate module (2) according to claim 1, wherein in the installed state, crossbars (26) extend between the end plates (20) below the lamella plates (22), which crossbars, in the region of their upper side facing the lamella plates (22), each have insertion recesses (260) for the insertion of a lamella plate (22) and can be detachably inserted into corresponding clamping slots (201) of the end plates (20) at the ends by projecting clamping hooks (261).

16. The plate module (2) according to claim 1, wherein in that in the installed state, an upper side (O) of the longitudinal plates (21) is inserted in a detachably clamping manner into a clamping strip (23) in the region of an insertion slot formed in the clamping strip (23).

17. The plate module (2) according to claim 1, wherein it is embodied with retaining rods (24) at the top in the installed state and with rollers (25) secured on the retaining rods (24), by which it is possible for the plate module (2) to be suspended on a support beam (13) of a settling basin (1, 1′).

18. The plate module (2) according to claim 1, wherein the end plates (20) are embodied with an upper flange (202) and/or the longitudinal plates (21) and/or the lamella plates are embodied with upper holes (221, 232) for a hoist.

19. The plate module (2) according to claim 1, wherein the end plates (20), longitudinal plates (21), and/or lamella plates (22) are made of sheet metal or plastic.

20. The plate module (2) according to claim 1, wherein the lamella plates (22) are embodied with a gradually increasing width starting from one end plate (20) to the other end plate (20) so that the plate module (2) is conical when viewed in the vertical projection.
